(19) United States
(12) Patent Application Publication
(10) Pub. No.: US 2014/0331117 A1
(43) Pub. Date: Nov. 6, 2014

(54) APPLICATION-BASED DEPENDENCY GRAPH

(71) Applicant: Qualcomm Innovation Center, Inc., San Diego, CA (US)

(72) Inventors: Bojin Liu, San Diego, CA (US); Rajiv K. Vijayakumar, San Diego, CA (US); Thomas M. Zakrajsek, San Diego, CA (US)

(21) Appl. No.: 13/887,710

(22) Filed: May 6, 2013

(51) Int. Cl. G06F 17/22

(52) U.S. Cl. CPC G06F 17/2247
USPC 715/234

(57) ABSTRACT

A computing device comprising a dependency graph creation portion adapted to create a dependency graph for identified content. At least a portion of the identified content comprises at least one of remotely-based content and one or more JavaScripts. A first resource tracker is adapted to provide the dependency graph creation portion with information related to a first portion of the remotely-based content upon a document object module builder initiating a request to receive the first portion of the remotely-based content. A first JavaScript tracker is adapted to provide the dependency graph creation portion with information related the one or more JavaScripts upon sending the one or more JavaScripts to a JavaScript Engine. A second JavaScript tracker adapted to provide the dependence graph creation portion with information received from the JavaScript Engine. A second resource tracker is adapted to provide the dependency graph portion with information related to a second portion of the remotely-based content upon a document object module style layout initiating a request to receive the second portion of the remotely-based content.

### BACKGROUND OF THE INVENTION

1. Field of the Invention

This invention is related to computing device applications which access remote content comprising one or more objects. Specifically, but not intended to limit the invention, embodiments of the invention are related to implementing features within the computing device application to create a dependency graph for the one or more remote content objects.

2. Relevant Background

The structure of remotely-based webpages is complicated. Such webpages are often comprised of several hundred different objects, and the objects may comprise several different object types. Some of these objects can lead to fetching of yet additional objects. In such cases, there is object dependency among the resources. Delays are often encountered in accessing these objects and using these objects in a user interface display on a computing device. The extended time it takes to access and subsequently display the remote content on the computing device may be due to slow computing device parsing performance. For example, providing insufficient power to processors and memory interconnects may lead to slow parsing performance. Further delay may occur due to high RTT cellular networks, which often impose a time overhead for each object fetched by the computing device.

### SUMMARY OF THE INVENTION

Overcoming the extended time it takes to access and subsequently display the remote content on the computing device described above may be accomplished by optimizing the fetching of the objects. Such optimization may create a better user web browsing experience as compared to an un-optimized object fetching, as optimized web sites may be more-quickly displayed on a computing device as compared to un-optimized web sites. Such optimization may occur by designing and structuring websites in a way that decreases the time it takes to load the website.

One embodiment of an invention adapted to provide optimized web sites comprises a computing device. One computing device comprises a dependency graph creation portion adapted to create a dependency graph for identified content. At least a portion of the identified content comprises at least one of remotely-based content and one or more JavaScripts. The computing device further comprises a first resource tracker adapted to provide the dependency graph creation portion with information related to a first portion of the remotely-based content upon a document object module builder initiating a request to receive the first portion of the remotely-based content. The computing device yet further comprises first JavaScript tracker adapted to provide the dependency graph creation portion with information related the one or more JavaScripts upon sending the one or more JavaScripts to a JavaScript Engine. The computing device yet further comprises a second JavaScript tracker adapted to provide the dependence graph creation portion with information received from the JavaScript Engine, and a second resource tracker adapted to provide the dependency graph portion with information related to a second portion of the remotely-based content upon a document object module style layout initiating a request to receive the second portion of the remotely-based content.

Another embodiment of the invention comprises a computing system. One computing system comprises a means for sending information related to a first portion of requested content to a dependency graph creator, a means for sending information related to one or more JavaScripts to the dependency graph creator, a means for sending information received from the JavaScript Engine to the dependency graph creator, and a means for sending information related to a second portion of requested content to the dependency graph creator.

And another embodiment of the invention comprises a method of identifying dependency of content. One method comprises requesting to receive a first portion of the content from one or more remotely-based devices, sending information related to the first portion of the content to a dependency graph creator, sending one or more JavaScripts to a JavaScript Engine, sending information related to the one or more JavaScripts to the dependency graph creator, providing the dependency graph creator with information received from the JavaScript Engine, requesting to receive a second portion of the content from one or more remotely-based devices, providing the dependency graph creator with information related to the second portion of the content, and taking into account the information related to the first portion of the content, the information related to the one or more JavaScripts, the information received from the JavaScript Engine, and the information related to the second portion of the content in using the dependency graph creator to create a dependency graph for the content.

Yet another embodiment of the invention comprises a non-transitory, tangible computer readable storage medium, encoded with processor readable instructions to perform a method of creating a dependency graph for an identified web page comprising, requesting to receive a first portion of content comprising the web page from one or more remote devices, sending information related to the first portion of content to a dependency graph creator, sending one or more JavaScripts provided within the identified web page to a JavaScript Engine, sending information related to the one or more JavaScripts to the dependency graph creator, providing the dependency graph creator with information received from the JavaScript Engine, requesting to receive a second portion of the content comprising the web page from one or more remote devices, providing the dependency graph creator with information related to the second portion of the content, and taking into account the information related to the first portion of content, the information related to the one or more JavaScripts, the information received from the JavaScript Engine, and the information related to the second portion of the content in using the dependency graph creator to create a dependency graph for the identified web page.

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

### BRIEF DESCRIPTION ON THE DRAWINGS

FIG. 1 illustrates a block diagram depicting components of a computing device and communication between a computing device and a remote computing device in a computing system;

FIG. 2 is a graphical representation of a dependency graph;

FIG. 3 illustrates a block diagram of an application;

FIG. 4 is a graphical representation of a DOM tree;

FIG. 5 is a flowchart that depicts a method that may be carried out in connection with the embodiments described herein; and

FIG. 6 illustrates a block diagram depicting components of a computing device.

### DETAILED DESCRIPTION

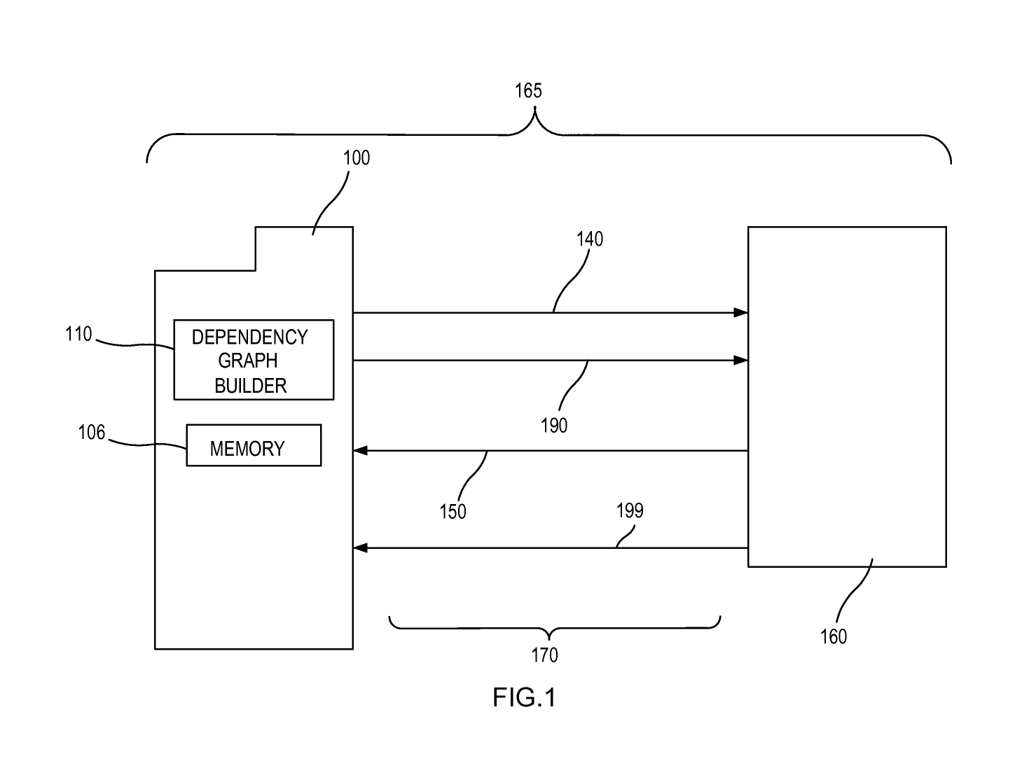

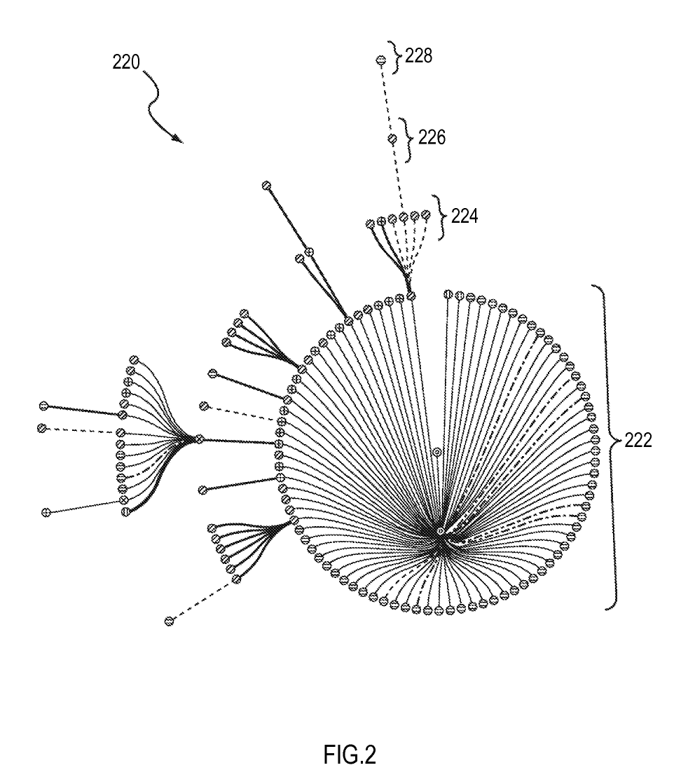

Turning first to FIG. 1, seen is a computing device 100 comprising a dependency graph creation portion 110 adapted to create a dependency graph, such as, but not limited to, the dependency graph 220 seen in FIG. 2, for identified content. The FIG. 2 dependency graph 220 is a graphical display of object dependency within a base-level object. However, the dependency graph may also comprise non-graphical textual or other types of data. One base-level object may comprise an HTML object/document adapted to display a web page on a web browser. Various objects may be referenced within the HTML object such, but not limited to, images, JavaScripts, and CSS documents. Upon accessing these objects within the HTML document, or through one or more levels of objects referenced within the HTML document, the web browser receives the object and may properly display the web page. It is contemplated that though the terms “web page,” “web browser,” and the like are used throughout the specification, embodiments of the invention may be used with any application or data provided to an application. Furthermore, the identified content may comprise the content with the HTML base-level object sought to be viewed on the web browser.

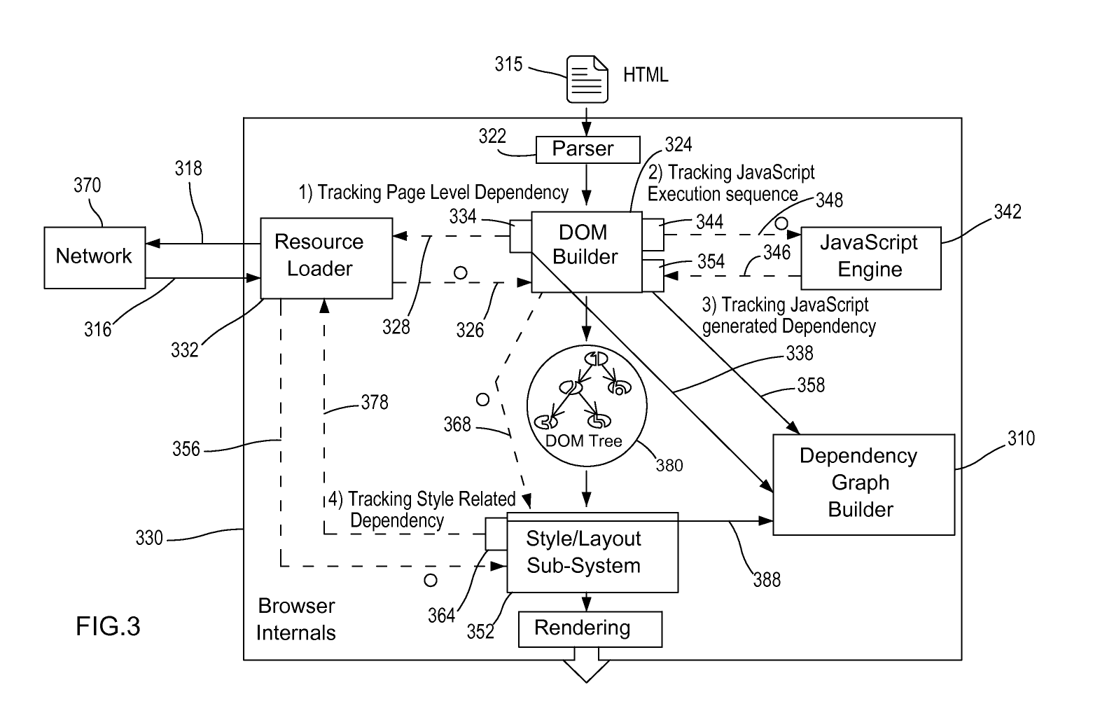

Seen in FIG. 3 is a block diagram representing one embodiment of a web browser 330 comprising the dependency graph creation portion 310. In one embodiment, and as seen in FIG. 1, upon submitting at least one request 140 to a remote computing device 160 through a network 170 to view a web page, the remote computing device 160 provides at least one response 150 to the computing 100, with the at least one response 150 comprising a base-level object 315, as seen in FIG. 3. The at least one request 140 may comprise at least one first request 140 and the at least one response may comprise an at least one first response 150. The web browser 330 downloads the base-level object 315 and a parser portion 322 of the web browser 330 may parse the base-level object 315 and create tokens according to the base-level object specifications. For example, different HTML tag and text tokens such as, but no limited to, a <body>, <img> and <script> token may be created. These tokens may be provided to a document object module builder portion 324.

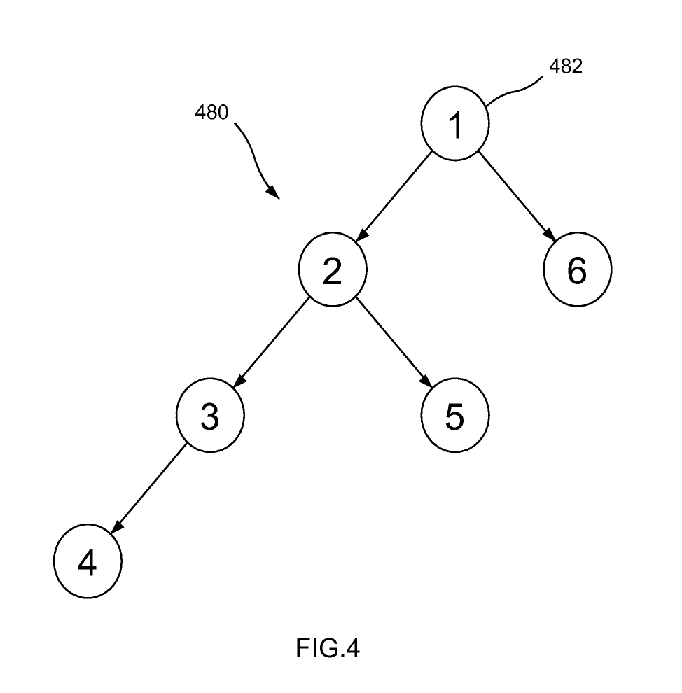

Using the tokens, the document object module builder portion 324 may build a document object module tree such as, but not limited to the tree 380, 480 seen in FIGS. 3 and 4, with each token corresponding to a node 482 in the tree 480. In one embodiment, the received base-level object 315 may identify at least one of remotely-based content and one or more JavaScripts. It is contemplated that the document object module builder portion 324 may also be referred to herein as the DOM builder 324.

In one such embodiment, the DOM builder 324 may comprise a first resource tracker 334 adapted to provide the dependency graph creation portion 310 with information related to the remotely-based content listed/identified within the base-level object 315. For example, the first resource tracker 334 may comprise a probe implemented between the DOM builder 324 and a resource loader 332. A resource loader 332 may comprise a web browser module adapted to fetch 318 and receive 316 an external resource (i.e., remotely-based content) listed within the base-level object 315. When the DOM builder 324 is building the DOM tree 480, upon the DOM builder finding that such external resources are needed to build the tree it may request 328 the external resource from the resource loader 332, which then issues the fetch 318 for the object. These external resources may comprise a first portion of remotely-based content identified within the DOM tree 380. The DOM tree 380, 480, may be referred to herein as a DOM or Document Object Module. Therefore, whenever the DOM builder issues the request 328 to load a resource from the network 370 because an external resource is discovered within the base-level object 315, the probe 334 forwards 338 information about the request 328 to the Dependency graph builder 310. Such information may comprise a timestamp or other time identifier of when the request 328 was sent and identifying information regarding the external resource sought in the request 328.

The web browser 310 may further comprise a first JavaScript tracker 344 adapted to provide the dependency graph creation portion 310 with information related the one or more JavaScripts upon sending the one or more JavaScripts to a JavaScript Engine 342. It is contemplated that the first JavaScript tracker 344 may also be referred to herein as a probe. Furthermore, the first JavaScript tracker 344, first resource tracker 334, and any other probes discussed herein may not be located within the web browser 330, but may be located in another portion of the mobile computing device 100, as seen in FIG. 1. For example, one or more of the probes may comprise a separate application. Similar to the first resource tracker 334, upon the DOM builder 324 finding a JavaScript within the base-level object 315 and sending 348 that JavaScript to the JavaScript Engine 342 for processing, the first JavaScript tracker 344, which may comprise a probe implemented at the out bound interface between the DOM builder 324 and the Engine 342, may identify that JavaScript is sent 348 and may send information regarding the sent JavaScript to the Dependency graph builder 310. Such information may comprise a timestamp or other time identifier of when the JavaScript was sent 348, identifying information regarding the sent JavaScript, and/or a sequence of which JavaScripts are sent to the Engine 342 to be executed.

One browser may further comprise a second JavaScript tracker 354 adapted to provide the dependency graph creation portion 310 with information received from the JavaScript Engine 342 at the DOM Builder 324. Such a second JavaScript tracker 354 probe may be implemented at the in-bound interface at the DOM Builder 324 between the DOM Builder 324 and the JavaScript Engine 342. In one embodiment, the probe 354 may provide information associated with the processed JavaScript to the Dependency Graph Builder 310. Such information may be related to modifying the DOM. For example, whenever the JavaScript Engine 342 modifies the DOM, which results in loading of external resources, the probe 354 may forward 358 the information to the dependency graph builder 310. The information may comprise information related to the external resource and timing information, as disclosed above with reference to the other probes. Furthermore, information regarding the JavaScript operation used to seek the external resource and/or modify the DOM may also be supplied. One type of JavaScript operation may include a document.write ( ) command, DOM node manipulation, XMLHttpRequest, or any other DOM modification commands. These commands 346 may add or remove DOM nodes.

In addition to the DOM Builder 324 receiving 326 the fetched resource from the resource loader 332 to build the DOM tree 380 and receiving commands 346 to modify the DOM tree 380, the DOM Builder 324 may also encounter style resources such as, but not limited to, CSS documents, that require processing. When such style resources are encountered, the style resource may be sent 368 to a style/layout module 352. In processing the resource, style/layout module 352 may find that the style resource requires other external resources such as, but not limited to an imported CSS or background images. In such an embodiment, the style/layout module may contact 378 the resource loader 332 to load these resources from the network 370. After the resource loader 332 loads the required resource, it will send 356 the resource to the style/layout module 352 for further processing. In one embodiment, a probe comprising a second resource tracker 364 may be implemented between the style/layout module 352 and the resource loader 332. Whenever the style/layout module 352 discovers that it needs to load an external resource, the probe 364 forwards 388 information related to the contact 378 to the dependency graph builder 310. Such external resource sought in the contact 378 may be referred to herein as a second portion of remotely-based content. In one embodiment, the second portion of remotely-based content may be sought upon the style/layout module 352 initiating a request (the contact 378) to receive the second portion of the remotely-based content.

In one embodiment, the term “identified content” may comprise content such as, but not limited to JavaScripts and remotely-based objects referenced in a source object such as, but not limited to, the base-level object 315. The first portion of the remotely-based content comprises content comprises content referenced within the source object, while the second portion of the remotely-based content may comprise remotely-based content referenced within another object besides the base-level object 315.

As seen in FIG. 3, at least one of the first JavaScript tracker 344 and second JavaScript tracker 354 may be communicatively coupled to the document object module builder 324. Furthermore, at least one of the first resource tracker 334, first JavaScript tracker 344, second JavaScript tracker 354, and second resource tracker 364 may comprise a portion of the web browser 310. As the first resource tracker 334, first JavaScript tracker 344, second JavaScript tracker 354, and second resource tracker 364 provide information to the Dependency graph creation portion 310, the dependency graph creation portion 310 uses the provided information to create the dependency graph 220, as seen in FIG. 2.

For example, upon receiving the plurality of objects listed within the base-level object 315 and any objects requested from the resource loader 332, the dependency graph creation portion 310 determines the order that the objects are requested in the at least one first request 140. This determination may be based on the time the request 318 is sent and/or the object is received 316 from the network 370. The dependency graph creation portion 310 may then create the DOM tree 380, 480 and/or dependency graph 220 based on this information.

In a dependency graph 220, the inner ring of objects 222 may comprise a base object dependency level, a first outer ring of objects 224 may comprise a first object dependency level, wherein each of the objects of the first object dependency level are dependent upon at least one object in the base object dependency level. The graph 220 further comprises a second outer ring of objects 226 comprising a second object dependency level, and a third outer ring of objects 228 comprising a third object dependency level, with each object in the second and third dependency levels being dependent upon at least one object in an immediately preceding dependency level.

From the dependency graph 220, the mobile computing device 200 may determine a quickest order for requesting the plurality of objects. For example, in the one or more second requests 190, the mobile computing device 100 may request one or more objects in the second dependency level or the third dependency level before an object in the first dependency level. It is to be appreciated that the base dependency level may be requested first. The mobile computing device 100 may take into account network characteristics to determine the new order to request the objects from the dependency graph 220.

The dependency graph creation portion 310 may further comprise determining the differences between these plurality of website object fetching orders. A website object fetching order may comprise the order in which the plurality of objects are requested in one or more first requests 140, second requests 190, or any further additional further requests and/or the order in which the plurality of objects are received in one or more first 150, one or more second responses 199, or one or more additional responses. The object fetching orders may then be merged by the dependency graph creation portion 310 to create a master object dependency file 220, as seen in FIG. 2, and the DOM tree 480, 380, seen in FIGS. 3 and 4.

The computing device of FIG. 1 may also be referred to as a computing system. Alternatively, a computing system may comprise the computing system 165 including one or more computing devices 100 an one or more remote computing device 160. One computing system 165 may comprise a means for sending information related to a first portion of requested content to a dependency graph creation portion 310. For example, the means may comprise the first resource tracker 334 disclosed above. The system 165 may also comprise a means for sending information related to one or more JavaScripts to the dependency graph creation portion 310. One such means may comprise the first JavaScript tracker 344 disclosed above. The system 165 may further comprise means for sending information received from the JavaScript Engine 342 to the dependency graph creation portion 310. One such means may comprise the second JavaScript tracker 354 discussed above. The system 165 may yet further comprise means for sending information related to a second portion of requested content to the dependency graph creation portion 310. One such means may comprise the second resource tracker 364 disclosed above.

One dependency graph creation portion 310 may comprise a portion of a computing device application such as, but not limited to, a web browser. In one embodiment, the content requested from the application may be identified in the received base-level object 315. Furthermore, the base-level object 315 may comprise an html source document received from at least of one or more remotely-based devices 160.

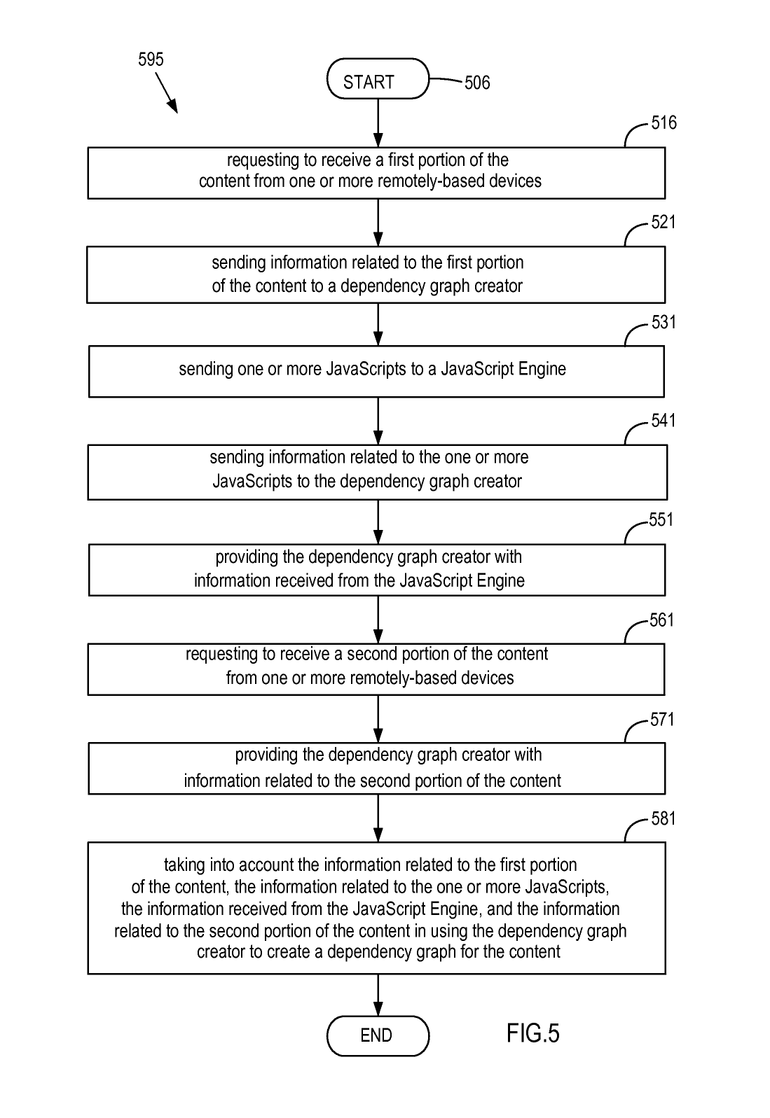

Turning now to FIG. 5, seen is a method 595 of identifying dependency of content. For example, the method 595 may comprise identifying the dependency of objects associated with the base-level object 315, as described above. One such method 595 starts at 506 and at 516 comprises requesting to receive a first portion of the content from one or more remotely-based devices. For example, such requesting may comprise the request 328 discussed above with reference to FIG. 3. At step 521, the method 360 comprises sending information related to the first portion of the content to a dependency graph creator. One dependency graph creator may comprise the dependency graph creation portion 310. The information related to the first portion of the content may comprise the information discussed above with reference to probe 334 forwarding 338 information about the request 328 to the dependency graph builder 310. At 531, the method 595 comprises sending one or more JavaScripts to a JavaScript Engine. For example, such a method step may be related to the JavaScripts disclosed with reference to the sending 348 disclosed above. At 541, the method 595 comprises sending information related to the one or more JavaScripts to the dependency graph creator. This step may be related to the probe 354 forwarding 358 information to the dependency graph builder 310, as disclosed above. At 551, the method 595 comprises providing the dependency graph creator with information received from the JavaScript Engine. This step may also be related to the probe 354 forwarding 358 information to the dependency graph builder 310, as disclosed above. At 561 the method 595 comprises requesting to receive a second portion of the content from one or more remotely-based devices. Such a method step may comprise the style/layout module 352 contacting 378 the resource loader 332 to load these resources from the network 370, as discussed above. At 571, the method 595 comprises providing the dependency graph creator with information related to the second portion of the content. Such a method step may be related to probe 364 forwarding 388 information related to the contact 378 such as a layout triggered resource received from the resource loaded 332, to the dependency graph builder 310. At 581, the method 595 comprises taking into account the information related to the first portion of the content, the information related to the one or more JavaScripts, the information received from the JavaScript Engine, and the information related to the second portion of the content such as layout triggered resources in using the dependency graph creator to create a dependency graph such as, but not limited to the graph 220 seen in FIG. 2. The tree 480 seen in FIG. 4 may also be created. The method 595 ends at 591.

In one method 595, the dependency graph creator comprises a portion of a computing device application. One computing device application comprises a web browser. Also, the step 516 of requesting to receive a first portion of the content from one or more remotely-based devices may comprise the request 328 issued by the document object module builder 324 upon receiving the base-level object 315. The base-level object may comprise an html source document received from at least one of the one or more remotely-based devices 160.

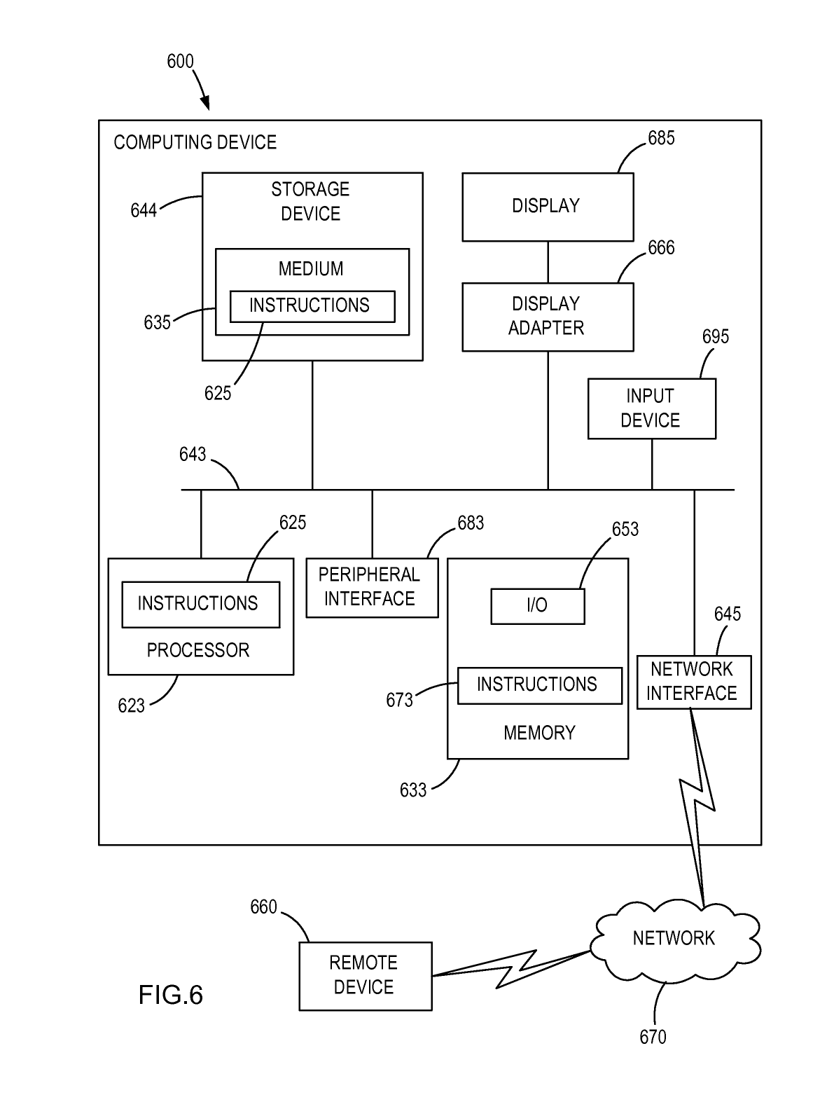

Another embodiment of the invention comprises non-transitory, tangible computer readable storage medium, encoded with processor readable instructions to perform a method of creating a dependency graph for an identified web page. One such method may comprise the method 595 seen in FIG. 5. In one embodiment, the storage medium may comprise the memory 106 seen in FIG. 1 or may comprise the storage device 644 or memory 633 seen with reference to FIG. 6. For example, in FIG. 6, shown is a diagrammatic representation of one embodiment of a machine in the exemplary form of the computing device 600 within which a set of instructions for causing a device to perform any one or more of the aspects and/or methodologies of the present disclosure to be executed.

Computing device 600 includes the processor 623, which communicates with the memory 633 and with other components, via the bus 643. Bus 643 may include any of several types of bus structures including, but not limited to, a memory bus, a memory controller, a peripheral bus, a local bus, and any combinations thereof, using any of a variety of bus architectures.

Memory 633 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 653 (BIOS), including basic routines that help to transfer information between elements within computing device 600, such as during start-up, may be stored in memory 633. Memory 633 may also include (e.g., stored on one or more machine-readable media) instructions (e.g., software) 673 which may comprise the dependency graph builder 110 seen in FIG. 1, the instructions 673 embodying any one or more of the aspects and/or methodologies of the present disclosure. In another example, memory 633 may further include any number of program modules including, but not limited to, an operating system, one or more application programs, other program modules, program data, and any combinations thereof.

Computing device 600 may also include a storage device 644. Examples of a storage device (e.g., storage device 644) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 644 may be connected to bus 643 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 644 may be removably interfaced with computing device 600 (e.g., via an external port connector (not shown)). Particularly, storage device 600 and an associated machine-readable medium 635 may provide nonvolatile and/or volatile storage of machine-readable instructions, data structures, program modules, and/or other data for computing device 600. In one example, instructions 625 may reside, completely or partially, within machine-readable medium 635. In another example, instructions 625 may reside, completely or partially, within processor 623.

Computing device 600 may also include an input device 695. In one example, a user of computing device 600 may enter commands and/or other information into computing device 600 via input device 695. Examples of an input device 695 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 695 may be interfaced to bus 643 via any of a variety of interfaces (not shown) including, but not limited to, a serial interface, a parallel interface, a game port, a USB interface, a FIREWIRE interface, a direct interface to bus 643, and any combinations thereof.

A user may also input commands and/or other information to computing device 400 via storage device 644 (e.g., a removable disk drive, a flash drive, etc.) and/or a network interface device 645 which may comprise a transmitter/receiver. In one embodiment, the transmitter/receiver comprises a wireless transmitter/receiver. A network interface device, such as network interface device 645 may be utilized for connecting computing device 600 to one or more of a variety of networks, such as network 670, and one or more remote devices 660 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 670, may employ a wired and/or a wireless mode of communication. In general, any network topology may be used. Information (e.g., data, software 625, etc.) may be communicated to and/or from computing device 600 via network interface device 645.

Computing device 600 may further include a video display adapter 666 for communicating a displayable image to a display device, such as display device 685. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computing device 600 may include one or more other peripheral output devices including, but not limited to, an audio speaker, a printer, and any combinations thereof. Such peripheral output devices may be connected to bus 643 via a peripheral interface 683. Examples of a peripheral interface include, but are not limited to, a serial port, a USB connection, a FIREWIRE connection, a parallel connection, and any combinations thereof. In one example an audio device may provide audio related to data of computing device 600 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 685. Accordingly, a digitizer may be integrated with display device 485, or may exist as a separate device overlaying or otherwise appended to display device 485.

In conclusion, embodiments of the present invention provide for the optimized processing of a webpage. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A computing device comprising,
a dependency graph creation portion adapted to create a dependency graph for identified content, wherein, at least a portion of the identified content comprises at least one of,
remotely-based content, and
one or more JavaScripts;
a first resource tracker adapted to provide the dependency graph creation portion with information related to a first portion of the remotely-based content upon a document object module builder initiating a request to receive the first portion of the remotely-based content;
a first JavaScript tracker adapted to provide the dependency graph creation portion with information related the one or more JavaScripts upon sending the one or more JavaScripts to a JavaScript Engine;
a second JavaScript tracker adapted to provide the dependence graph creation portion with information received from the JavaScript Engine; and
a second resource tracker adapted to provide the dependency graph portion with information related to a second portion of the remotely-based content upon a document object module style layout initiating a request to receive the second portion of the remotely-based content.

2. The computing device of claim 1 wherein,
the identified content comprises content referenced in a source object; and
the first portion of the remotely-based content comprises content comprises content referenced within the source object.

3. The computing device of claim 1 wherein, at least one of the first JavaScript tracker, and second JavaScript tracker are communicatively coupled to the document object module builder.

4. The computing device of claim 1 wherein, at least one of the first resource tracker, resource tracker, first JavaScript tracker, second JavaScript tracker, and second resource tracker comprise a portion of a web browser.

5. The computing device of claim 1 wherein, the information received from the JavaScript Engine comprises information related to modifying a document object module.

6. The computing device of claim 5 wherein,
the information related to modifying a document object module comprises information related to one or more external resources; and
modifying the document object module comprise at least one of,
a document.write( ) command,
document object module manipulation, and
an XMLHttpRequest.

7. The computing device of claim 1 wherein, the dependency graph creation portion 110 is further adapted to,
create a dependency graph for the identified content; and
associating timing information with the identified content.

8. The computing device of claim 1 wherein, the identified content comprises a web page.

9. A computing system comprising,
means for sending information related to a first portion of requested content to a dependency graph creator;
means for sending information related to one or more JavaScripts to the dependency graph creator;
means for sending information received from the JavaScript Engine to the dependency graph creator; and
means for sending information related to a second portion of requested content to the dependency graph creator.

10. The computing system of claim 9 wherein, the dependency graph creator comprises a portion of a computing device application.

11. The computing system of claim 10 wherein, the computing device application comprises a web browser.

12. The computing system of claim 9 wherein, the requested content is identified in a received base-level object.

13. The computing system of claim 12, wherein, the base-level object comprises an html source document received from at least of one or more remotely-based devices.

14. A method of identifying dependency of content comprising,
requesting to receive a first portion of the content from one or more remotely-based devices;
sending information related to the first portion of the content to a dependency graph creator;
sending one or more JavaScripts to a JavaScript Engine;
sending information related to the one or more JavaScripts to the dependency graph creator;
providing the dependency graph creator with information received from the JavaScript Engine;
requesting to receive a second portion of the content from one or more remotely-based devices;
providing the dependency graph creator with information related to the second portion of the content; and
taking into account the information related to the first portion of the content, the information related to the one or more JavaScripts, the information received from the JavaScript Engine, and the information related to the second portion of the content in using the dependency graph creator to identify dependency of the content.

15. The method of claim 10 wherein,
the dependency graph creator comprises a portion of a computing device application; and
identifying dependency of the content comprises creating one of,
a dependency graph, and
a DOM tree.

16. The method of claim 11, wherein, the computing device application comprises a web browser.

17. The method of claim 10 wherein, the requesting to receive a first portion of the content from a remotely-based device is issued by a document object module builder upon receiving a base-level object.

18. The method of claim 13, wherein, the base-level object comprises an html source document received from at least one of the one or more remotely-based devices.

19. A non-transitory, tangible computer readable storage medium, encoded with processor readable instructions to perform a method of creating a dependency graph for an identified web page comprising,
requesting to receive a first portion of content comprising the web page from one or more remote devices;
sending information related to the first portion of content to a dependency graph creator;
sending one or more JavaScripts provided within the identified web page to a JavaScript Engine;
sending information related to the one or more JavaScripts to the dependency graph creator;
providing the dependency graph creator with information received from the JavaScript Engine;
requesting to receive a second portion of the content comprising the web page from one or more remote devices;
providing the dependency graph creator with information related to the second portion of the content; and
taking into account the information related to the first portion of content, the information related to the one or more JavaScripts, the information received from the JavaScript Engine, and the information related to the second portion of the content in using the dependency graph creator to create a dependency graph for the identified web page.

20. The method of claim 10 wherein, the dependency graph creator comprises a portion of a computing device application.

21. The method of claim 11, wherein, the computing device application comprises a web browser.

22. The method of claim 10 wherein, the requesting to receive a first portion of the content from a remotely-based device is issued by a document object module builder upon receiving a base-level object.
